(19) United States
(12) Patent Application Publication
(10) Pub. No.: US 2026/0280293 A1
(43) Pub. Date: Sep. 17, 2026

(54) Systems and Methods for Resynchronization of Micro-Grids with Larger Power Grids

(71) Applicant: ABB Schweiz AG, Baden (CH)

(72) Inventors: Aniket M. Joshi, Raleigh, NC (US); Alexander Brissette, Raleigh, NC (US)

(73) Assignee: ABB Schweiz AG, Baden (CH)

(21) Appl. No.: 19/471,771

(22) PCT Filed: Apr. 14, 2023
(86) PCT No.: PCT/IB2023/053851

§ 371 Date: Oct. 2, 2025

(51) Int. Cl. H02J 3/08; H02J 3/388; H02J 3/40

(52) U.S. Cl. CPC H02J 3/08; H02J 3/388; H02J 3/40

(57) ABSTRACT

A method for synchronizing a micro-grid with a larger electrical grid is provided. The method comprises: receiving, by a computing system, a plurality of first sensor measurements from one or more first sensors; receiving, by the computing system, a plurality of second sensor measurements from one or more second sensors; determining, by the computing system, whether the micro-grid is synchronized with the larger electrical grid based on the plurality of first sensor measurements and the plurality of second sensor measurements; based on the micro-grid being not synchronized with the larger electrical grid, controlling, by the computing system, one or more energy assets of the micro-grid by providing one or more correcting characteristics to the energy assets; and based on the micro-grid being synchronized with the larger grid, providing, by the computing system, instructions to the circuit breaker to connect the micro-grid to the larger electrical grid.

### FIELD

The present disclosure relates to resynchronization of islanded micro-grids with larger power grids.

### BACKGROUND

A micro-grid is a local electrical grid with defined electrical boundaries. The micro-grid may include electrical components such as loads and/or energy generation devices that generate electrical energy. In some instances, the micro-grid may include operating modes such as an island mode and a connected mode. In a connected mode, the micro-grid may be connected to a larger electrical grid (e.g., an electrical grid of a city or state). In an island mode, the micro-grid may operate as an island (e.g., disconnected from the larger electrical grid). The micro-grid and the larger grid may operate at different operating parameters (e.g., different voltages). When switching between the island mode and the connected mode, certain resynchronization processes may be performed. However, traditional resynchronization processes typically used complex and costly methods that involved many types of devices and focused more on fault detection rather than re-connection. Many of these approaches fail to mention how they align with Institute of Electrical and Electronics Engineers (IEEE) reconnection standards, fail to realize the approach from a dispatch-able inverter based distributed energy resources (DER) perspective, and implement complex and computationally heavy power sharing techniques. Accordingly, there remains a technical need for a simple, scalable, and generalized resynchronization process for resynchronizing micro-grids with larger energy grids.

### SUMMARY

A first aspect of the present disclosure provides a method for synchronizing a micro-grid with a larger electrical grid, comprising: receiving, by a computing system, a plurality of first sensor measurements from one or more first sensors, wherein the plurality of first sensor measurements indicate first magnitude, first frequency, and first angle measurements on a micro-grid side of a circuit breaker that electrically connects the micro-grid to the larger electrical grid; receiving, by the computing system, a plurality of second sensor measurements from one or more second sensors, wherein the plurality of second sensor measurements indicate second magnitude, second frequency, and second angle measurements on a larger grid side of the circuit breaker; determining, by the computing system, whether the micro-grid is synchronized with the larger electrical grid based on the plurality of first sensor measurements and the plurality of second sensor measurements; based on the micro-grid being not synchronized with the larger electrical grid, controlling, by the computing system, one or more energy assets of the micro-grid by providing one or more correcting characteristics to the one or more energy assets; and based on the micro-grid being synchronized with the larger grid, providing, by the computing system, instructions to the circuit breaker to connect the micro-grid to the larger electrical grid.

According to an implementation of the first aspect, the method further comprises: receiving, from a static transfer switch, larger grid information indicating a health of the larger electrical grid; determining a state of the micro-grid, wherein the state indicates whether the micro-grid is in a connected state or an island state, and wherein determining whether the micro-grid is synchronized with the larger electrical grid is further based on the larger grid information indicating the larger electrical grid is healthy and the state of the micro-grid indicates that the micro-grid is in the island state.

According to an implementation of the first aspect, the circuit breaker is a point of common coupling (PCC) between the micro-grid and the larger electrical grid, wherein the one or more first sensors are configured to obtain the plurality of first sensor measurements from one or more electrical lines that connect the micro-grid to the circuit breaker, and wherein the one or more second sensors are configured to obtain the plurality of second sensor measurements from one or more electrical lines that connect the circuit breaker to the larger electrical grid.

According to an implementation of the first aspect, determining whether the micro-grid is synchronized with the larger electrical grid comprises: determining a difference between the first magnitude with the second magnitude, wherein the first magnitude and the second magnitude indicate voltage magnitude measurements; comparing the difference with one or more thresholds; and determining whether the micro-grid is synchronized based on the comparison.

According to an implementation of the first aspect, determining whether the micro-grid is synchronized with the larger electrical grid comprises: determining a difference between the first frequency with the second frequency, wherein the first frequency and the second frequency indicate frequencies of voltage waveforms; comparing the difference with one or more thresholds; and determining whether the micro-grid is synchronized based on the comparison.

According to an implementation of the first aspect, determining whether the micro-grid is synchronized with the larger electrical grid comprises: determining a difference between the first angle with the second angle, wherein the first angle and the second angle indicate phase angles; comparing the difference with one or more thresholds; and determining whether the micro-grid is synchronized based on the comparison.

According to an implementation of the first aspect, determining the difference between the first angle with the second angle is based on the first magnitude being synchronized with the second magnitude and the first frequency being synchronized with the second frequency.

According to an implementation of the first aspect, the one or more correcting characteristics comprise a voltage magnitude resynchronization value, wherein the one or more energy assets adjusts a voltage magnitude of the micro-grid based on the voltage magnitude resynchronization value.

According to an implementation of the first aspect, the one or more correcting characteristics comprise a voltage frequency resynchronization value, wherein the one or more energy assets adjusts a voltage frequency of the micro-grid based on the voltage frequency resynchronization value.

According to an implementation of the first aspect, the one or more correcting characteristics comprise an angle error, wherein the one or more energy assets adjusts a voltage frequency of the micro-grid based on the angle error.

According to an implementation of the first aspect, providing the instructions to the circuit breaker further comprises: obtaining, from the one or more first sensors, a plurality of subsequent sensor measurements during a waiting period; determining whether the micro-grid is stable during the waiting period based on comparing the plurality of subsequent sensor measurements with one or more stability thresholds; and based on determining the micro-grid is stable during the waiting period, providing the instructions to the circuit breaker to connect the micro-grid to the larger electrical grid.

According to an implementation of the first aspect, the method further comprises: receiving, by the computing system, user input indicating the waiting period.

According to an implementation of the first aspect, the plurality of first sensor measurements comprise a first set of sensor measurements obtained by the one or more first sensors at a first instance in time and a second set of sensor measurements obtained by the one or more first sensors at a second instance in time, wherein determining whether the micro-grid is synchronized comprises: determining whether the micro-grid is synchronized with the larger electrical grid at the first instance in time based on the first set of sensor measurements; and determining whether the micro-grid is synchronized with the larger electrical grid at the second instance in time based on the second set of sensor measurements.

According to an implementation of the first aspect, controlling the one or more energy assets of the micro-grid by providing the one or more correcting characteristics to the one or more energy assets is based on determining that the micro-grid is not synchronized with the larger electrical grid at the first instance in time, and wherein providing the instructions to the circuit breaker to connect the micro-grid to the larger electrical grid is based on determining that the micro-grid is not synchronized with the larger electrical grid at the second instance in time.

A second aspect of the present disclosure provides a system for synchronizing a micro-grid with a larger electrical grid. The system comprises: a computing system, comprising one or more processors; and a non-transitory computer-readable medium having processor-executable instructions stored thereon, wherein the processor-executable instructions, when executed by the one or more processors, facilitate: receiving a plurality of first sensor measurements from one or more first sensors, wherein the plurality of first sensor measurements indicate first magnitude, first frequency, and first angle measurements on a micro-grid side of a circuit breaker that electrically connects the micro-grid to the larger electrical grid; receiving a plurality of second sensor measurements from one or more second sensors, wherein the plurality of second sensor measurements indicate second magnitude, second frequency, and second angle measurements on a larger grid side of the circuit breaker; determining whether the micro-grid is synchronized with the larger electrical grid based on the plurality of first sensor measurements and the plurality of second sensor measurements; based on the micro-grid being not synchronized with the larger electrical grid, controlling one or more energy assets of the micro-grid by providing one or more correcting characteristics to the one or more energy assets; and based on the micro-grid being synchronized with the larger grid, providing instructions to the circuit breaker to connect the micro-grid to the larger electrical grid.

According to an implementation of the second aspect, the processor-executable instructions, when executed by the one or more processors, further facilitate: receiving, from a static transfer switch, larger grid information indicating a health of the larger electrical grid; determining a state of the micro-grid, wherein the state indicates whether the micro-grid is in a connected state or an island state, and wherein determining whether the micro-grid is synchronized with the larger electrical grid is further based on the larger grid information indicating the larger electrical grid is healthy and the state of the micro-grid indicates that the micro-grid is in the island state.

According to an implementation of the second aspect, the circuit breaker is a point of common coupling (PCC) between the micro-grid and the larger electrical grid, wherein the one or more first sensors are configured to obtain the plurality of first sensor measurements from one or more electrical lines that connect the micro-grid to the circuit breaker, and wherein the one or more second sensors are configured to obtain the plurality of second sensor measurements from one or more electrical lines that connect the circuit breaker to the larger electrical grid.

According to an implementation of the second aspect, determining whether the micro-grid is synchronized with the larger electrical grid comprises: determining a difference between the first magnitude with the second magnitude, wherein the first magnitude and the second magnitude indicate voltage magnitude measurements; comparing the difference with one or more thresholds; and determining whether the micro-grid is synchronized based on the comparison.

According to an implementation of the second aspect, determining whether the micro-grid is synchronized with the larger electrical grid comprises: determining a difference between the first frequency with the second frequency, wherein the first frequency and the second frequency indicate frequencies of voltage waveforms; comparing the difference with one or more thresholds; and determining whether the micro-grid is synchronized based on the comparison.

A third aspect of the present disclosure provides a non-transitory computer-readable medium having processor-executable instructions stored thereon. The processor-executable instructions, when executed by one or more controllers, facilitate: receiving a plurality of first sensor measurements from one or more first sensors, wherein the plurality of first sensor measurements indicate first magnitude, first frequency, and first angle measurements on a micro-grid side of a circuit breaker that electrically connects the micro-grid to the larger electrical grid; receiving a plurality of second sensor measurements from one or more second sensors, wherein the plurality of second sensor measurements indicate second magnitude, second frequency, and second angle measurements on a larger grid side of the circuit breaker; determining whether the micro-grid is synchronized with the larger electrical grid based on the plurality of first sensor measurements and the plurality of second sensor measurements; based on the micro-grid being not synchronized with the larger electrical grid, controlling one or more energy assets of the micro-grid by providing one or more correcting characteristics to the one or more energy assets; and based on the micro-grid being synchronized with the larger grid, providing instructions to the circuit breaker to connect the micro-grid to the larger electrical grid.

### BRIEF DESCRIPTION OF THE DRAWINGS

Embodiments of the present disclosure will be described in even greater detail below based on the exemplary figures. The present disclosure is not limited to the exemplary embodiments. All features described and/or illustrated herein can be used alone or combined in different combinations in embodiments of the present disclosure. The features and advantages of various embodiments of the present disclosure will become apparent by reading the following detailed description with reference to the attached drawings which illustrate the following:

FIG. 1 illustrates a simplified block diagram depicting an exemplary environment for resynchronizing micro-grids with larger grids according to one or more examples of the present disclosure;

FIG. 2 illustrates a simplified block diagram of one or more devices or systems within the exemplary environment of FIG. 1;

FIG. 3 illustrates a simplified block diagram depicting another exemplary environment for resynchronizing micro-grids with larger grids according to one or more examples of the present disclosure;

FIG. 4 illustrates a process for resynchronizing micro-grids with larger grids according to one or more examples of the present disclosure;

FIG. 5 depicts an exemplary input/output map for resynchronizing micro-grids with larger grids according to one or more examples the present disclosure;

FIG. 6 illustrates another process for resynchronizing micro-grids with larger grids according to one or more examples of the present disclosure; and

FIGS. 7-10 illustrates another process for resynchronizing micro-grids with larger grids according to one or more examples of the present disclosure.

### DETAILED DESCRIPTION

Exemplary aspects according to the present disclosure, are further elucidated below in connection with exemplary embodiments, as depicted in the figures. The exemplary embodiments illustrate some implementations of the present disclosure and are not intended to limit the scope of the present disclosure. Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on”.

The present disclosure describes a system and method for resynchronizing micro-grids with larger electrical grids. For instance, in some examples, the present disclosure describes a power management approach for dispatch-able DERs towards resynchronization of islanded micro-grids with a larger power grid. For example, the present disclosure provides a system and method to control islanded micro-grid by aligning PCC waveforms with that of the larger grid. This is accomplished by simultaneously controlling dispatch-able DERs in the island in terms of frequency and voltage. In some instances, the present disclosure provides built-in voltage drop compensation control, which generalizes the approach and makes it applicable for a wider range of islanded operating conditions and has faster resynchronization capability. In some instances, the present disclosure does not use complex measurement devices such as synchro-phasors. Instead, in such instances, the present disclosure uses a simple voltage angle, magnitude, and frequency measurement units/sensors on either side of the interconnection circuit breaker.

In some variations, the present disclosure provides a simple, scalable, and a generalized size-based power sharing approach that is designed based on the IEEE 1547 standard for resynchronization of DER-based islanded micro-grid to the larger grid. The present disclosure uses an algorithm that takes differences between the point of common coupling (PCC) side and grid side waveform parameters such as frequency, angle and magnitude and sends out voltage and frequency control set-points for DER-based grid forming inverters in the island such that the errors between PCC and grid side frequency, angle and magnitude are minimized. Additionally, and/or alternatively, the algorithm also checks whether these parameters are within acceptable resynchronization tolerance limits. If those conditions continue to hold for a user-defined “Enter Service” wait period, the algorithm commands the PCC circuit breaker to close and reestablish connection to the larger grid and simultaneously, commands DER inverters to change from grid-forming mode to grid-following mode control.

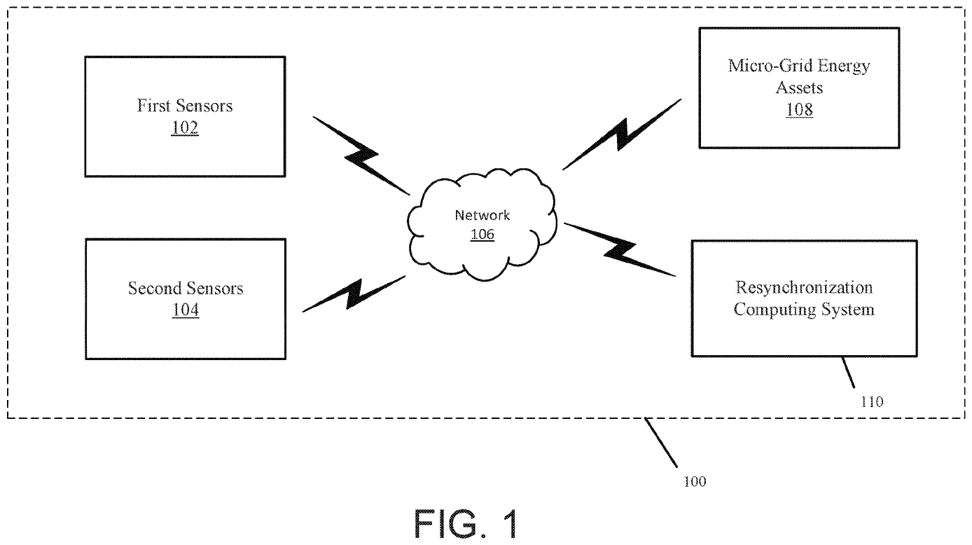

FIG. 1 illustrates a simplified block diagram depicting an exemplary environment for resynchronizing micro-grids with larger grids according to one or more examples of the present disclosure. Referring to FIG. 1, the environment 100 may be a power system or any other type of system that comprises an electrical grid. The electrical grid may include a main power network (e.g., larger electrical grid) and one or more micro-grids. Micro-grids may be and/or include a group of electrical devices. For instance, micro-grids may have electrical boundaries of low voltage distributed energy resources (DER) and loads that may be operated in a controlled, coordinated way. The micro-grid may operate in a connected mode (e.g., a mode that connects the micro-grid to the larger electrical grid and controlled as a single source from the perspective of the larger grid) and an island mode (e.g., a mode that disconnects the micro-grid from the larger electrical grid).

The micro-grid may be connected to the larger electrical grid via one or more circuit breakers. For instance, the circuit breaker may be used to control whether the micro-grid operates in the connected mode or the island mode (e.g., whether the micro-grid is connected to the larger electrical grid). The circuit breaker may be part of and/or be associated with a PCC between the micro-grid and the larger electrical grid. In some instances, the circuit breaker may be an SACE EMAX 2 circuit breaker.

The entities within the environment 100 may be in communication with other systems within the environment 100 via the network 106. The network 106 may be a global area network (GAN) such as the Internet, a wide area network (WAN), a local area network (LAN), or any other type of network or combination of networks. The network 106 may provide a wireline, wireless, or a combination of wireline and wireless communication between the entities within the environment 100. For example, the first and second sensors 102 and 104 may be connected to the resynchronization computing system 110 via a wired connection and/or a wireless connection.

The first sensors 102 and the second sensors 104 include one or more sensors that are configured to provide sensor information to the resynchronization computing system 110. For example, the first sensors 102 may be located or positioned between the micro-grid and the circuit breaker. The first sensors 102 may provide first sensor measurements indicating electrical characteristics on the micro-grid side. The second sensors 104 may be located or positioned between the circuit breaker and the larger electrical grid. The second sensors 104 may provide second sensor measurements indicating electrical characteristics on the larger electrical grid side. The electrical characteristics indicated by the sensor measurements of the first and second sensors 102, 104 may be any type of electrical characteristics including voltage, frequency, angle, and/or other types of electrical characteristics. In some examples, the first and second sensors 102, 104 may be voltage and/or frequency sensors that are configured to measure and provide the voltage and frequency to the resynchronization computing system 110. In some variations, the first and/or second sensors 102 and 104 might not include smart relays and/or synchro-phasor devices.

The resynchronization computing system 110 (“computing system 110”) is a computing system that includes one or more computing devices, computing platforms, systems, servers, and/or other apparatuses capable of performing tasks, functions, and/or other actions for the environment 100. In particular, the computing system 110 may communicate with the first sensors 102 and the second sensors 104 as well as the micro-grid energy assets 108. For example, the computing system 110 may receive sensor measurements from the first sensors 102 and the second sensors 104. Based on the measurements, the computing system 110 may determine correcting characteristics such as voltage resynchronizations, frequency resynchronizations, angle resynchronizations, and/or other types of electrical characteristics. The computing system 110 may provide the correcting characteristics to the micro-grid energy assets 108. Based on the correcting characteristics, the micro-grid energy assets 108 may absorb and/or provide energy (e.g., power) to the micro-grid electrical system. Based on the absorption of energy or providing the energy, the computing system 110 may determine to switch the micro-grid from the island mode to the connected mode. This will be explained in further detail below.

In some variations, the computing system 110 may be implemented using one or more computing platforms, devices, servers, and/or apparatuses. In other variations, the computing system 110 may be implemented as engines, software functions, and/or applications. In other words, the functionalities of the computing system 110 may be implemented as software instructions stored in storage (e.g., memory) and executed by one or more processors.

In some examples, the computing system 110 may be a computing device that is associated with the micro-grid. For instance, the computing system 110 may be a computing device that is located within the micro-grid and is configured to control one or more functions of the micro-grid. In other examples, the computing system 110 may be a computing device that is associated with the circuit breaker. For instance, the circuit breaker may include and/or be associated with a computing device 110 that is configured to control the circuit breaker and/or the micro-grid. In yet other examples, the computing system 110 may be a cloud computing system that controls one or more micro-grids and/or the larger grid.

The micro-grid energy assets 108 may be and/or include one or more energy assets of the micro-grid. For instance, the energy assets 108 may include and/or be distributed energy resources (DERs) such as renewable energy sources and/or batteries (e.g., battery energy storage systems (BESS)). Additionally, and/or alternatively, the energy assets 108 may be and/or include plants (e.g., power plants and/or virtual power plants (VPP)) and/or other types of energy assets 108 that are configured to generate energy/power for the micro-grid and/or absorb energy/power from the micro-grid. The VPPs may be an aggregated system of energy assets that are controlled by a software-based platform.

It will be appreciated that the exemplary environment depicted in FIG. 1 is merely an example, and that the principles discussed herein may also be applicable to other environments.

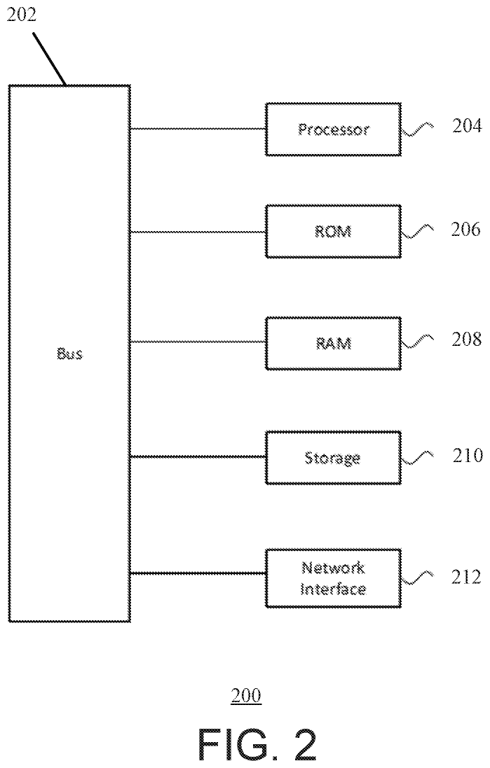

FIG. 2 is a block diagram of an exemplary system and/or device 200 (e.g., the computing system 110) within the environment 100. The device/system 200 includes a processor 204, such as a central processing unit (CPU), controller, and/or logic, that executes computer executable instructions for performing the functions, processes, and/or methods described herein. In some examples, the computer executable instructions are locally stored and accessed from a non-transitory computer readable medium, such as storage 210, which may be a hard drive or flash drive. Read Only Memory (ROM) 206 includes computer executable instructions for initializing the processor 204, while the random-access memory (RAM) 208 is the main memory for loading and processing instructions executed by the processor 204. The network interface 212 may connect to a wired network or cellular network and to a local area network or wide area network, such as the network 106. The device/system 200 may also include a bus 202 that connects the processor 204, ROM 206, RAM 208, storage 210, and/or the network interface 212. The components within the device/system 200 may use the bus 202 to communicate with each other. The components within the device/system 200 are merely exemplary and might not be inclusive of every component, server, device, computing platform, and/or computing apparatus within the device/system 200.

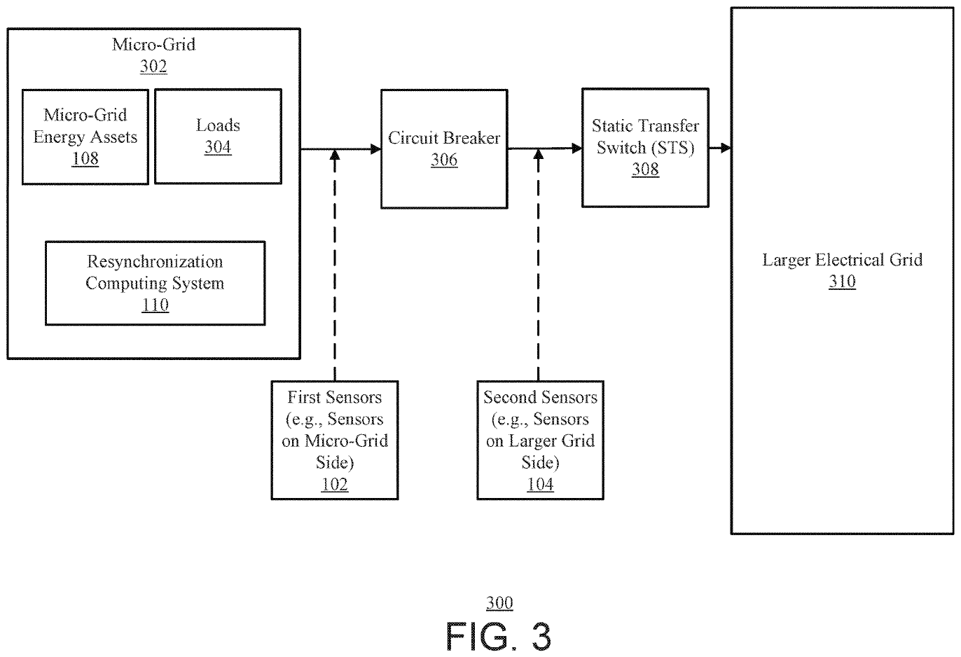

FIG. 3 illustrates a simplified block diagram depicting another exemplary environment for resynchronizing micro-grids with larger grids according to one or more examples of the present disclosure. For instance, the environment 300 may be an exemplary power grid or power system. The environment 300 may similar to environment 100, but also shows additional components such as the micro-grid 302, the larger electrical grid 310, the circuit breaker 306, and other components.

For example, the environment 300 includes the micro-grid 302. The micro-grid 302 may be an electrical grid that includes micro-grid energy assets 108, which are described above, and loads 304. The loads 304 may include commercial loads, industrial loads, and/or other types of loads that are configured to use electrical energy. The micro-grid energy assets 108 may be configured to provide energy (e.g., power) to the micro-grid 302 and/or absorb energy from the micro-grid 302. For instance, the micro-grid energy assets 108 may include DERs such as BESS and/or renewable energy sources. The micro-grid 302 further includes the computing system 110. As mentioned above, the environment 300 is merely exemplary and in other examples, the computing system 110 may be located outside of the micro-grid 302 (e.g., the computing system 110 may be coupled to the circuit breaker 306 and/or may be a cloud computing system that is located in the cloud).

The micro-grid 302 is connected to the larger electrical grid 310 via a circuit breaker 306 and a static transfer switch (STS) 308. The circuit breaker 306 may be any type of circuit breaker that is configured to connect and/or disconnect the micro-grid 302 to the larger electrical grid 310. For instance, the circuit breaker 306 may be an SACE EMAX 2 circuit breaker. The STS 308 are devices that switches between electrical power sources. The first sensors 102 are located on the micro-grid side (e.g., between the micro-grid 302 and the circuit breaker 306). The second sensors 104 are located on the larger grid side (e.g., between the circuit breaker 306 and the larger electrical grid 310).

The computing system 110 may be in communication with one or more devices within the environment 300 such as the micro-grid energy assets 108, the first sensors 102, the second sensors 104, the circuit breaker 306, the STS 308, and/or other devices/components.

It will be appreciated that the exemplary environment depicted in FIG. 3 is merely an example, and that the principles discussed herein may also be applicable to other environments. For example, the larger electrical grid 310 may be associated with a plurality of micro-grids 302. The plurality of micro-grids 302 may be associated with a plurality of circuit breakers 306, first sensors 102, and second sensors 104. In operation, the plurality of micro-grids 302 may operate in the island mode or the connected mode.

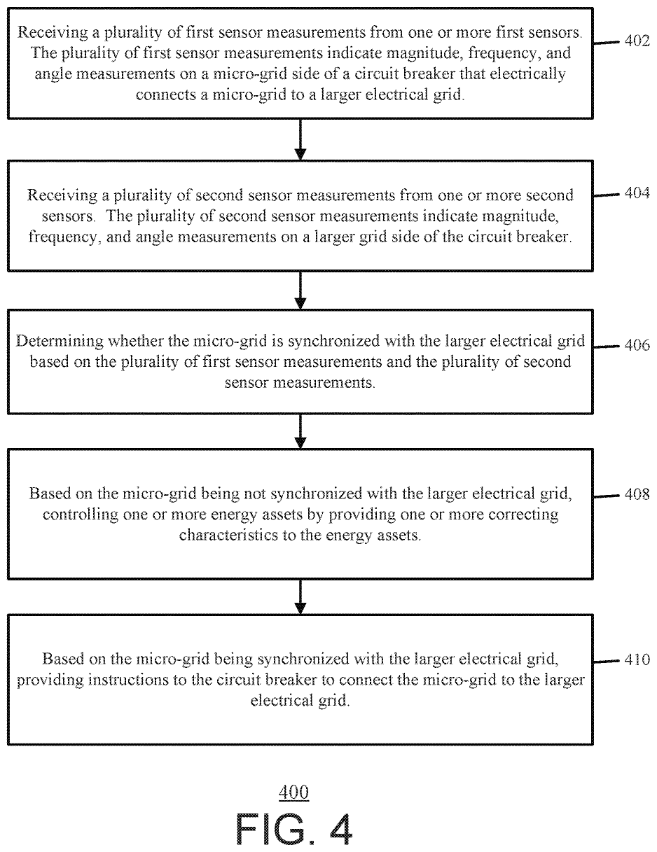

FIG. 4 illustrates a process for resynchronizing micro-grids with larger grids according to one or more examples of the present disclosure. The process 400 may be performed by the computing system 110 that is shown in FIGS. 1 and/or 3. However, it will be recognized that any of the following blocks may be performed in any suitable order and that the process 400 may be performed in any suitable environment and by any suitable device and/or system.

In operation, at block 402, the computing system 110 receives a plurality of first sensor measurements from one or more first sensors 102. The plurality of first sensor measurements indicate magnitude, frequency, and angle measurements (e.g., first magnitude, first frequency, and first angle measurements) on a micro-grid side of a circuit breaker (e.g., circuit breaker 306) that electrically connects a micro-grid (e.g., micro-grid 302) to a larger electrical grid (e.g., larger electrical grid 310). For example, as shown in FIG. 3, the computing system 110 may be in communication with the first sensors 102. The first sensors 102 may obtain electrical characteristics from the micro-grid side of the circuit breaker 306 (e.g., electrical characteristics associated with one or more electrical lines between the micro-grid 302 and the circuit breaker 306). The electrical characteristics may include voltage measurements such as voltage magnitudes, frequencies, and/or angle measurements (e.g., phase angle measurements). For instance, in some variations, the first sensors 102 may include sensors that are configured to measure the magnitude of the voltage of the electrical lines between the micro-grid 302 and the circuit breaker 306. Additionally, and/or alternatively, the first sensors 102 may measure the frequency of these electrical lines (e.g., rate of oscillation of a voltage signal). For instance, the micro-grid 302 may use alternating current (AC) (e.g., three-phase AC power) that cycles at regular intervals (e.g., frequencies). To connect the micro-grid 302 to the larger electrical grid 310, the computing system 110 may seek to synchronize the waveforms or signals of the micro-grid 302 (e.g., the magnitude and frequency of the voltage waveforms) with the waveforms of the larger grid 310. For instance, when operating in an island mode, the micro-grid 302 may operate with different voltage waveforms as compared to the waveforms from the larger grid 310. In order to synchronize with the larger grid 310, the micro-grid 302 may seek to match or substantially match the waveforms of the micro-grid 302 with the waveforms of the larger grid 310. Therefore, at block 402, the first sensors 102 may be configured to obtain measurements of the waveforms of the micro-grid 302 such as the magnitude and/or frequency of the waveforms (e.g., the voltage magnitude and/or the frequency of the voltage waveform). Furthermore, the first sensors 102 may be configured to obtain the phase angle of the micro-grid 302 (e.g., the lag or lead between the voltage and/or current waveforms of the micro-grid 302). The first sensors 102 may provide these measurements to the computing system 110.

At block 404, the computing system 110 receives a plurality of second measurements from one or more second sensors 104. The plurality of second measurements indicate magnitude, frequency, and angle measurements (e.g., second magnitude, second frequency, and second angle measurements) on a larger grid side of the circuit breaker (e.g., circuit breaker 306). For instance, referring to FIG. 3, the second sensors 104 may measure the electrical characteristics of the electrical lines between the circuit breaker 306 and the larger electrical grid 310. In some instances, the second sensors 104 may measure the electrical characteristics between the circuit breaker 306 and the STS 308. The electrical characteristics may indicate magnitude, frequency, and/or angle (e.g., phase angle) measurements associated with the larger electrical grid 310. For instance, the electrical characteristics may indicate the voltage magnitude, the frequency of the voltage signal, and/or the phase angle of the larger electrical grid 310. The second sensors 104 may provide these measurements to the computing system 110.

At block 406, the computing system 110 determines whether the micro-grid (e.g., the micro-grid 302) is synchronized with the larger electrical grid (e.g., electrical grid 310) based on the plurality of first sensor measurements and the plurality of second sensor measurements. For instance, the computing system 110 may compare one or more measurements from the first sensor measurements with one or more measurements from the second sensor measurements. For example, the computing system 110 may compare the voltage magnitudes of the first and second sensor measurements to determine whether the micro-grid is synchronized. For instance, the computing system 110 may determine a difference between the voltage magnitudes of the first and second sensor measurements. The computing system 110 may further compare the difference with one or more thresholds (e.g., zero, substantially zero, or a different value) such as a voltage magnitude threshold. Based on the comparison, the computing system 110 may determine whether the micro-grid 302 is synchronized with the larger electrical grid 310. For instance, based on the difference being below the threshold, the computing system 110 may determine that the micro-grid 302 is synchronized. Based on the difference being above the threshold, the computing system 110 may determine that the micro-grid 302 is not synchronized.

Additionally, and/or alternatively, the computing system 110 may compare the frequencies and/or angles of the first and second sensor measurements. For instance, the computing system 110 may compare the differences between the frequencies and/or angles of the first and second sensor measurements with one or more thresholds such as frequency and/or angle thresholds. Based on the comparison, the computing system 110 may determine whether the micro-grid 302 is synchronized. For instance, based on all three of the differences of the magnitude, frequency, and angles being below the threshold, the computing system 110 may determine that the micro-grid 302 is synchronized. Otherwise, the computing system 110 may determine the micro-grid 302 is not synchronized.

In other words, the computing system 110 compares electrical characteristic measurements (e.g., voltage magnitude, frequency, and angle) from either side of the circuit breaker 308. The micro-grid side indicates the electrical characteristic measurements of the micro-grid 302 and the larger grid side indicates the electrical characteristic measurements of the larger grid 310. The computing system 110 may determine differences between the two sides (e.g., the micro-grid side and the larger grid side). Based on the differences reaching substantially zero and/or being below a threshold, the computing system 110 may determine that the micro-grid 302 is synchronized with the larger electrical grid 310 (e.g., based on the voltage magnitude, frequency, and/or angle of the micro-grid matching or nearly matching the voltage magnitude, frequency, and/or angle of the larger grid 310, the computing system 110 may determine that the micro-grid 302 is synchronized with the larger electrical grid 310).

At block 408, based on the micro-grid being not synchronized with the larger electrical grid, the computing system 110 controls one or more energy assets (e.g., the micro-grid energy assets 108) by providing one or more correcting characteristics to the energy assets. For instance, the computing system 110 may provide information indicating correcting characteristics to the energy assets 108. For example, as mentioned above, the energy assets 108 may include DERs, renewable energy sources, BESS, and/or other types of energy assets. The energy assets 108 may seek to follow micro-grid waveform (e.g., voltage magnitude, frequency, and/or angle associated with the micro-grid 302). The computing system 110 may provide correcting characteristics such as voltage resynchronizations (e.g., a voltage resynchronization magnitude value), frequency resynchronizations (e.g., a frequency resynchronization value), and/or angle errors to the energy assets 108. Based on providing the correcting characteristics, the energy assets 108 may adjust their energy production and/or absorption. For example, the energy assets 108 may be and/or include one or more BESS. The BESS may provide energy to the micro-grid 302 and/or absorb energy from the micro-grid 302 based on the correcting characteristics. By providing and/or absorbing energy, the BESS may alter the waveforms of the micro-grid 302. For instance, the correcting characteristics may indicate a voltage resynchronization. Based on the voltage resynchronization, the BESS may provide additional energy into the micro-grid 302 so as to alter the voltage waveform to reduce or increase the magnitude of the voltage waveform. By reducing or increasing the magnitude of the voltage waveform, the first sensors 102 may obtain new sensor measurements that are closer to and/or in sync with the voltage magnitude of the larger electrical grid 310. Additionally, and/or alternatively, the computing system 110 may provide correcting characteristics such as frequency resynchronizations and/or angle errors. The BESS may alter the frequency and/or angle of the waveforms of the micro-grid 302 to align them with the frequency and/or angle of the waveforms from the larger electrical grid 310. Additionally, and/or alternatively, the energy assets 108 may include DERs such as renewable energy sources. The renewable energy sources may alter their provided power to the micro-grid 302 based on the correcting characteristics. For instance, the renewable energy sources may generate additional and/or reduced power based on the voltage resynchronization from the computing system 110 and/or may change the frequency and/or angle of the generated power based on the frequency resynchronization and/or the angle error.

In some instances, blocks 402, 404, 406, and/or 408 may repeat one or more times. For instance, based on the micro-grid not being synchronized, the computing system 110 may provide the correcting characteristics. The energy assets 108 may adjust and/or alter the waveform of the micro-grid 302 based on the correcting characteristics (e.g., increase or reduce the magnitude of the voltage waveform). In the next iteration, the computing system 110 may receive new first sensor measurements (e.g., updated sensor measurements) indicating new magnitude, frequency, and angle measurements on the micro-grid side of the circuit breaker. The computing system 110 may compare the new first sensor measurements with the second sensor measurements (e.g., the original second sensor measurements or additional/new second sensor measurements that were taken after providing the correcting characteristics). Based on the comparison, the computing system 110 may determine whether the micro-grid is synchronized. If the micro-grid is not synchronized, the computing system 110 may determine and provide one or more new correcting characteristics to the energy assets. Then, blocks 402, 404, 406, and/or 408 may repeat until the micro-grid is synchronized.

At block 410, based on the micro-grid being synchronized with the larger electrical grid, the computing system 110 provides instructions to the circuit breaker to connect the micro-grid to the larger electrical grid. As such, the micro-grid may be changed from an island mode to a connected mode. In other words, the circuit breaker may complete the circuit such that the micro-grid 302 is connected to the larger electrical grid 310 based on the instructions from the computing system 110.

In some instances, the computing system 110 may determine whether the micro-grid side is stable prior to providing the instructions. For example, the computing system 110 may determine a waiting period (e.g., a user-defined and/or pre-defined waiting period) such as 300 seconds. After the waiting period elapses, the computing system 110 may provide the instructions to the circuit breaker 306. The computing system 110 may obtain one or more sensor measurements (e.g., from the first sensor 102) during the waiting period (e.g., obtaining subsequent sensor measurements). Using the subsequent sensor measurements, the computing system 110 may determine whether the micro-grid magnitude, frequency, and angle are stable (e.g., comparing them with one or more stability thresholds). For instance, if there is a change in these measurements, the process 400 may repeat so as to not connect the micro-grid 302 to the larger grid 310 at that time. After the waiting period elapses (e.g., after 300 seconds), the computing system 110 may provide the instructions to the circuit breaker to connect the micro-grid 302 to the larger electrical grid 310. The process 400 will be described in further detail below.

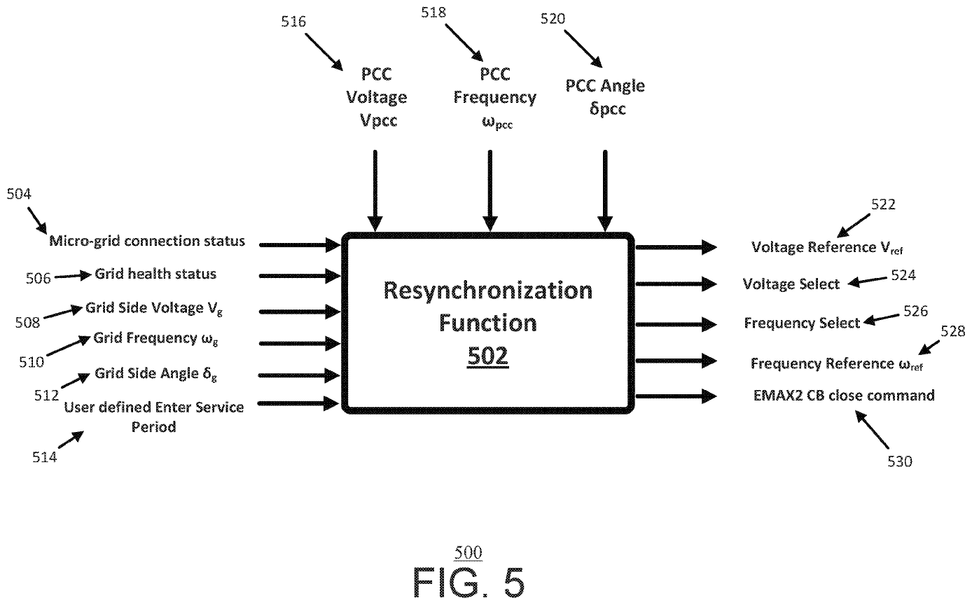

FIG. 5 depicts an exemplary input/output map 500 for resynchronizing micro-grids with larger grids according to one or more examples the present disclosure. For instance, the input/output map 500 includes a resynchronization function 502 that may be performed by the computing system 110 and/or one or more systems. For example, process 400 may be part of and/or associated with the resynchronization function 502. The resynchronization function 502 may include inputs such as the micro-grid connection status 504, the grid health status 506, the grid side voltage 508, the grid frequency 510, the grid side angle 512, the user-defined enter service period 514, the PCC voltage 516, the PCC frequency 518, and the PCC angle 520. For instance, the computing system 110 may obtain the inputs 504-520. Based on the inputs 504-520, the resynchronization function 502 may provide the outputs such as the voltage reference 522, the voltage select 524, the frequency select 526, the frequency reference 528, and the EMAX 2 CB close command 530.

The resynchronization function 502 may be associated with a simulation time step Ts (e.g., 50 microseconds (μs)). The micro-grid connection status 504 may indicate whether the micro-grid 302 is connected to the larger electrical grid 310. For instance, the micro-grid connection status 504 (e.g., “MI”) may indicate a “1” if the micro-grid is operating in an island mode and a “0” if the micro-grid is operating in a connected mode. The grid health status 506 (e.g., “STS”) may indicate an STS grid status such as a “1” if the larger electrical grid 310 is healthy and “0” if the larger electrical grid 310 is not healthy. The grid side voltage 508 (“V_{g}”) indicates the voltage at the micro-grid circuit breaker 306 on the grid side (e.g., the larger grid side). The PCC voltage 516 (“V_{pcc}”) indicates the micro-grid side PCC voltage at the circuit breaker 306. In other words, the PCC voltage 516 indicates the voltage on the micro-grid side of the circuit breaker 306 and the grid side voltage 508 indicates the voltage on the larger grid side of the circuit breaker 306. The computing system 110 may determine a difference between these two voltages “ΔV”, which is equal to V_{g}−V_{pcc}. The grid frequency 510 (“ω_{g}”) indicates the frequency on the grid side of the circuit breaker 306 (e.g., the frequency of the larger grid side of the circuit breaker 306). The PCC frequency 518 (“ω_{pcc}”) indicates the frequency on the micro-grid side of the circuit breaker 306. The computing system 110 may determine a difference between these two frequencies “Δω”, which may be equal to ω_{g}−ω_{pcc}. The grid side angle 512 (“δ_{g}”) indicates the grid side angle of the circuit breaker 306 (e.g., the angle at the larger grid side of the circuit breaker 306). The PCC angle 520 (“δ_{pcc}”) indicates the micro-grid side angle of the circuit breaker 306. The computing system 110 may determine a difference between these two angles “Δδ”, which may be equal to δ_{g}−δ_{pcc}.

Based on the inputs 504-520, the computing system 110 may use the resynchronization function 502 to determine the outputs 522-530. The voltage reference (“V_{ref}”) may indicate a voltage reference. The frequency reference (“ω_{ref}”) may indicate a frequency reference. The voltage reference and the frequency reference may be based on the voltage and frequency resynchronizations that are described above. The voltage select 524 may be a toggle signal that allows the micro-grid to track either nominal voltage (e.g., 1 per unit (p.u.)) or track the larger grid voltage (V_{g}) and the frequency select 526 may be a toggle signal that allows the micro-grid to track either nominal frequency (60 hertz (Hz)) or track the larger grid frequency (ω_{g}). The EMAX2 CB close command 530 may indicate a command to close the circuit breaker 306 (e.g., to change the micro-grid 302 from the island mode to the connected mode so as to connect it to the larger grid 310).

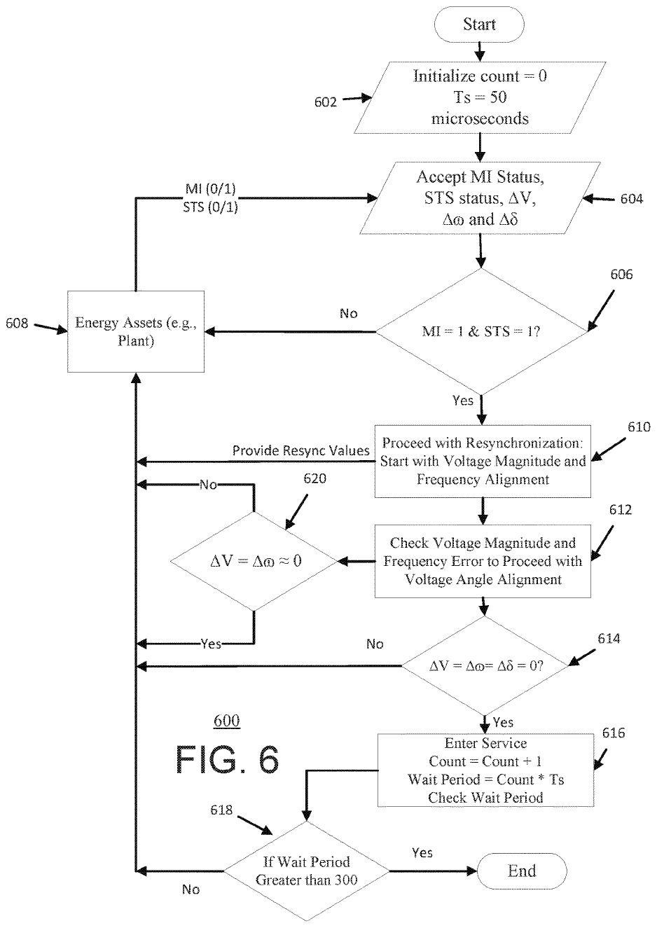

FIG. 6 illustrates another process for resynchronizing micro-grids with larger grids according to one or more examples of the present disclosure. The process 600 may be performed by the computing system 110 that is shown in FIGS. 1 and/or 3. However, it will be recognized that any of the following blocks may be performed in any suitable order and that the process 600 may be performed in any suitable environment and by any suitable device and/or system.

In operation, at block 602, the computing system 110 may initialize a count (e.g., count=0) and initialize the Ts (e.g., Ts=50 microseconds).

At block 604, the computing system 110 accepts the MI status, the STS status, and/or obtains/determines the differences (e.g., ΔV, Δω and Δδ). Initially, the computing system 110 might not obtain the differences, but after a first iteration, the computing system 110 may obtain the differences.

At block 606, the computing system 110 determines whether the MI is 1 and whether the STS is 1. If so, process 600 moves to block 610. If not, process 600 moves to block 608. For instance, MI=1 and STS=1 indicates that the larger grid 310 is healthy and the micro-grid 302 is operating in the island mode. If either are 0 (e.g., larger grid 310 is not healthy and micro-grid 302 is operating in a connected mode), then process 600 goes to 608 and repeats. For instance, the computing system 110 provides initial voltage V₀ and initial frequency ω₀ to the energy assets. At block 608, the energy assets 608 continue performing normally based on the initial voltage and initial frequency.

At block 610, the computing system 110 proceeds with resynchronization. In particular, the computing system 110 starts with the voltage magnitude and frequency alignment. For instance, the computing system 110 may perform blocks 402, 404, 406, and/or 408 for the voltage magnitude and frequency alignment. For example, the computing system 110 may compare voltage magnitudes and frequencies between the first and second sensors 102, 104 to determine differences between them. The computing system 110 may determine they are not synchronized and provide resync values (resynchronization values) such as correcting characteristics (e.g., voltage resynchronizations (V_{resynch}) and frequency resynchronizations (ω_{resynch})) to the energy assets 108. Then, at block 608, the energy assets 108 may determine voltage and frequency references (e.g., reference values) based on the correcting characteristics (e.g., voltage resynchronizations and frequency resynchronizations). The process 600 may continuously repeat until they are resynchronized. In some instances, the frequency resynchronization may be equal to the difference in frequencies (e.g., Δω_{f}).

At block 612, after the voltage magnitude and the frequencies are synchronized, the computing system 110 checks voltage magnitude and frequency error to proceed with voltage angle alignment. For instance, the computing system 110 may perform certain checks in series. Initially, the computing system 110 checks to ensure that the voltage magnitude and frequencies are in sync. Then, the computing system 110 performs resynchronization of the voltage angle. For instance, at block 620, the computing system 110 checks whether the difference in voltage and the difference in frequency are substantially close to zero. If no, the computing system 110 proceed similarly to block 608 and provides correcting characteristics such as voltage resynchronizations and frequency resynchronizations. In some instances, the frequency resynchronization may be equal to the difference in frequencies (e.g., Δω_{f}).

If yes, the computing system 110 provides correcting characteristics such as voltage resynchronizations and frequency resynchronizations. In some instances, the frequency resynchronization may be equal to the difference in frequencies (e.g., Δω_{f}) plus the difference in the frequency component for the angle alignment (e.g., “Δω_{δ}”). For instance, ω_{reynch}=Δω_{f}+Δω_{δ}. In other words, the frequency (ω_{reynch}) that the micro-grid must operate on in order to align the micro-grid to the larger grid in terms of frequency is equal to the frequency component (Δω_{f}) required for frequency alignment plus the frequency component required for angle alignment (Δω_{δ}).

At block 614, the computing system 110 determines whether the differences in the voltage magnitude, frequency, and angle are substantially equal to 0. If no, the process 600 moves to block 608. For instance, if any of the voltage, frequency, or angle are not equal to 0, process 600 may provide additional correcting characteristics to the energy assets 108. Then, at block 608, the energy assets 108 may adjust the voltage, frequency, and/or angle. Then, process 600 repeats and steps 602-614 and 620 may be re-performed. If yes, process 600 moves to block 616.

In other words, at blocks 602-614 and 620, the computing system 110 may perform resynchronization by checking the differences between the voltage magnitudes, frequencies, and angles. Based on the differences, the computing system 110 may provide correcting characteristics such as voltage and frequency resynchronizations (e.g., resync values) and/or angle errors. The energy assets 108 may determine references such as voltage and/or frequency references and adjust the waveforms for the micro-grid accordingly. After, process 600 may repeat and new measurements may be obtained. After the voltage, frequency, and angle differences are substantially 0 (e.g., they are synced), process 600 moves to block 616.

At block 616, the computing system 110 enters service, updates the count to be count +1, determines the wait period as the count * Ts, and checks the wait period. As mentioned above, the computing system 110 may check for stability of the micro-grid (e.g., the differences between the voltage, frequency, and angle are substantially 0 for an extended period of time such as 300 seconds).

At block 618, the computing system 110 checks if the wait period is greater than 300. If so, the computing system 110 sends a command signal (e.g., for the circuit breaker 306 to close) such as an EMAX2 CB close signal, and process 600 ends. If not, the computing system 110 may move back to block 608 and re-perform process 600. For instance, the computing system 110 may provide a command signal such as EMAX 2 CB open.

In other words, depending on the status checks performed by the process 600 on the micro-grid connection, grid health, ΔV, Δω, and Δδ, the computing system 110 switches the voltage and frequency references for the DER integrated control based on the correcting characteristics.

Referring to process 600, the blocks 602-620 may be performed multiple times. For instance, initially, the computing system 110 determines the health of the grid and the current DER operating conditions. Then, the computing system 110 may perform code execution for the differences in voltage and frequency and angle control, and perform data acquisition. Following, the computing system 110 may perform control execution for cascade control on the DERs. Then, this may repeat, the computing system 110 determines the health of the grid and the current DER operating conditions. Then, the computing system 110 may perform code execution for the differences in voltage frequency and angle control, and perform data acquisition. Following, the computing system 110 may perform control execution for cascade control on the DERs. Further, the computing system 110 may determine the health of the grid and the current DER operating conditions again. Based on the resynchronization conditions being met, the computing system 110 may resynch condition fulfillment control and data acquisition and enter service and intentional delay (e.g., 0-300 seconds). Then, the computing system 110 may perform EMAX 2 circuit breaker closure (e.g., command the circuit breaker to close). Following, the computing system 110 may resynch condition fulfillment control and data acquisition and enter service intentional delay (e.g., 300-600 seconds).

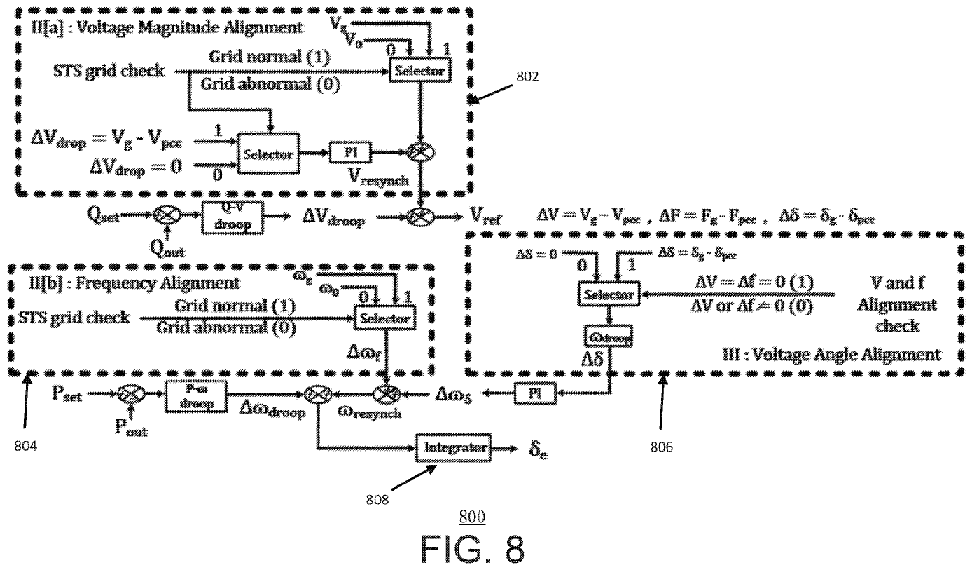

In some instances, the computing system 110 augments the P-ω and Q-V droop with additional active and reactive power setpoints that are responsible for aligning the waveform during the resynchronization process. For instance, P-ω and Q-V droop refer to the conventional P (active power)−ω (frequency) droop control loop and Q (reactive power)−V (voltage) droop control loop shown and described in FIG. 8below. This enables multiple DERs to share the control setpoints that drive the micro-grid towards synchronism with the larger grid. First, the computing system 110 checks the connection status of the micro-grid and the STS grid health. If the grid is found in healthy (normal) condition and the micro-grid is in the islanded state, the computing system 110 initiates the resynchronization process. Otherwise, it keeps on checking the above-mentioned statuses until they become TRUE.

Second, the computing system 110 aims at minimizing ΔV and Ao such that they are within the IEEE-1547-2018-4.10.4 parameter limits.

Third, the computing system 110 ensures that ΔV and Ao are within parameter limits and then engages 48 control.

Once ΔV, Δω and Δδ are all minimized, the computing system 110 initiates an enter service period. Here, the micro-grid power is controlled using the ramp rate limits specified by IEEE-1547-2018-4.10.3. If the enter service wait period exceeds a user-defined wait period (e.g., 300 seconds), the computing system 110 closes the circuit breaker. Otherwise, the circuit breaker stays open. Once the circuit breaker closes, the DER control is shifted back to grid following mode. In some instances, the enter service ramp rate limits continue to be enforced for another 300 seconds after the circuit breaker closes.

In some variations, during islanded condition, the dispatch-able DERs (e.g., the energy assets 108) operate in grid forming mode, where they are responsible for maintaining the island voltage and frequency at nominal values of 1 per unit (p.u.). The computing system 110 uses the resynchronization function 520 to check the grid health status through a STS and when it finds the grid to be healthy, it initiates the resynchronization process. The computing system 110 uses a proportional-integral (PI)-control-based voltage drop compensation loop to the forming mode voltage control. The voltage magnitude alignment uses this loop implementation. This enables the tracking of the PCC voltage magnitude after compensating for any voltage drops in the micro-grid.

The objective of resynchronization is to align the PCC voltage waveform in magnitude, frequency, and phase with respect to the larger grid. After Resynch initiation, the voltage magnitude alignment and frequency alignment are achieved. The accuracy and success of these alignments are defined by acceptable tolerance band parameters.

Once magnitude and frequency are aligned, the phase alignment by activating Voltage Angle Alignment is performed. In this sequence, the dispatch-able DER frequency is changed in such a way that the grid angle δ_{g} is aligned with PCC angle δ_{pcc}. This achieved through PI-control that generates an extra frequency set-point (Δω_{δ}) for the dispatchable DER inverter. After all the PCC waveform parameters of voltage (e.g., magnitude, frequency, and phase) are aligned and within tolerance band, the computing system 110 performs the next sequence in the algorithm (e.g., the Enter Service check and Circuit Breaker Closure. The Enter Service specifications are defined as an intentional delay (0-600 seconds) when the micro-grid steady-state voltage and frequency are within the specified. After the Enter Service wait period is over, the resynchronization process finishes with the PCC circuit breaker closure and toggling of the dispatch-able DER control into following mode. At this stage the micro-grid moves into grid-connected mode with the closure of the PCC circuit breaker. This will be described in further detail below.

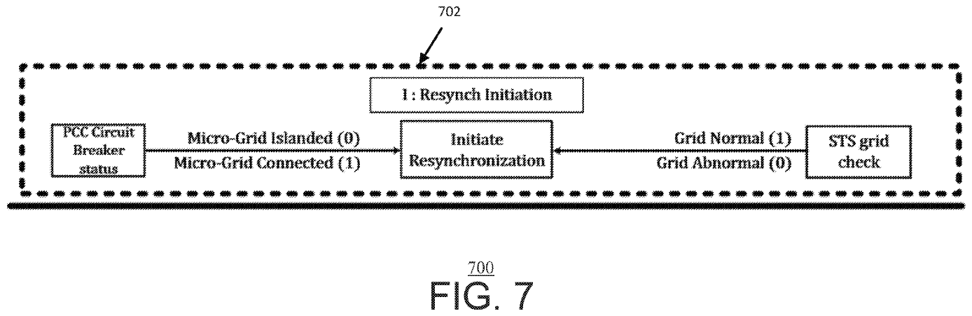

FIGS. 7-10 illustrates another process 700-1000 for resynchronizing micro-grids with larger grids according to one or more examples of the present disclosure. During islanded condition, Distributed Energy Resources (DERs) operate in grid forming mode, where they are responsible for maintaining the island voltage and frequency at nominal values of 1 p.u. A computing system (e.g., the resynchronization computing system 110) may use the resynchronization function to check the grid health status through a Static Transfer Switch (STS) and when it finds the grid to be healthy, it initiates the resynchronization process. The resynchronization process is disabled during grid connected conditions. FIG. 7 shows the PCC connection statuses that are used to enable the resynchronization function. For instance, FIG. 7 shows the resynchronization initiation function that is performed by the computing system. The computing system may use the PCC circuit breaker status and the STS grid check to determine whether to initiate resynchronization between the micro-grid and the larger grid.

Referring to FIG. 8, once the resynchronization function is initiated, voltage alignment sequence 802 and frequency alignment sequence 804 are enabled simultaneously. For instance, the computing system may perform the voltage and frequency alignment sequences 802 and 804. In some examples a grid forming voltage control loop is made to track the grid voltage, Vg instead of nominal Voltage V₀. In some instances, the forming control mode only tracks the voltage and frequency references at its DER inverter terminal. Thus, any voltage drop between inverter terminal and the PCC must be accounted for. This is achieved by adding a proportional-integral (PI)-control-based voltage drop compensation loop to the forming mode voltage control. The voltage magnitude alignment sequence 802 is shown in FIG. 8 Section II[a]. This enables the computing system to track the PCC voltage magnitude after compensating for any voltage drops in the micro-grid. The Qset and Qout are the reactive power setpoints and output values of the DER while in the grid-forming mode. The reactive power-voltage droop loop generates a ΔVdroop voltage adjustment that the DER must track. The grid forming frequency control loop 804 is given the reference grid frequency, Og instead of nominal frequency ω₀. Since frequency is a global entity, the PCC frequency is same as the inverter terminal frequency and hence no compensation control is required for successfully tracking frequency reference. The Pset and Pout are the active power setpoints and output values of the DER while in the grid-forming mode. The active power-frequency droop loop generates a Δω_{droop} frequency adjustment that the DER must track. The frequency alignment sequence 804 is shown in FIG. 8 Section II[b]. FIG. 8 shows that frequency alignment component for DER is Δω_{f} and there also an additional alignment component, Δω_{δ}, which comes from the next sequence the algorithm, called angle alignment 806. Once magnitude and frequency are aligned, the phase alignment is performed by activating Angle Alignment 806 (Algorithm Sequence III). In this sequence, the DER frequency is changed in such a way that the PCC angle δ_{pcc} is aligned with the grid angle δg. This is achieved through PI-control that generates an extra frequency set-point (Δω_{δ}) for the DER inverter. The angle alignment sequence 806 is shown in FIG. 8 Section III. The integrator block 808 acts on the final frequency reference ω_{ref} to generate an equivalent inverter angle δe for its operation.

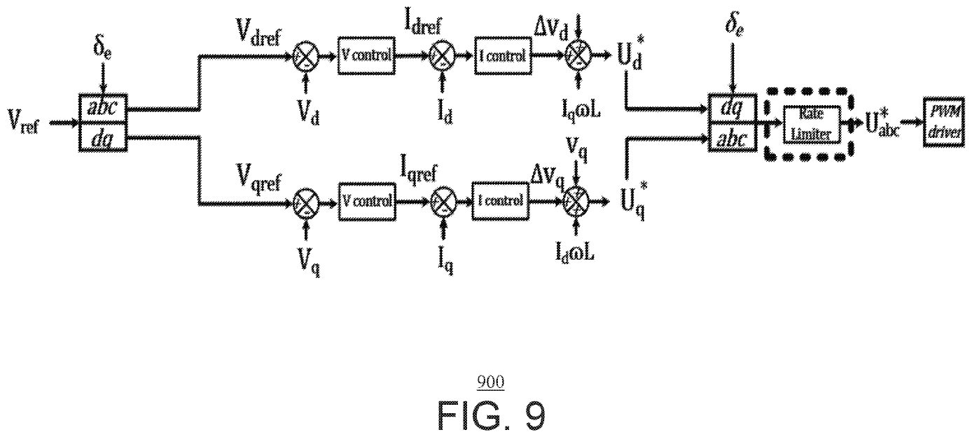

FIG. 9 shows inverter d-q (direct-quadrature axis) control, which is a control structure in DER inverters. Vref and δe are Voltage magnitude and angle reference signals for inverter to operate on. These signals may be converted from abc-domain to dq-domain into Vdref and Vqref, direct and quadrature axis reference voltages, respectively. The measured direct and quadrature axis voltages, Vd and Vq are compared with these reference signals to generate an error signal that goes through a Proportional-Integral (PI) controller. The output of the PI loop generates equivalent direct and quadrature axis currents, Iqref and Iqref, respectively. These current references are sent through another PI loop to generate the direct and quadrature axis components of voltage, ΔVd and ΔVq. These signals are de-coupled by accounting for the effect created by the mutual reactances, IqωL and IdωL, respectively. Finally, the output is added to the measured direct and quadrature axis voltages, Vd and Vq to generate the inverter dq-domain reference voltage signals,

$${U}_{d}^{*} and {U}_{q}^{*} ,$$

respectively. These are converted back to the abc-domain voltage signal

$${U}_{abc}^{*}$$

with drive the inverter PWM.

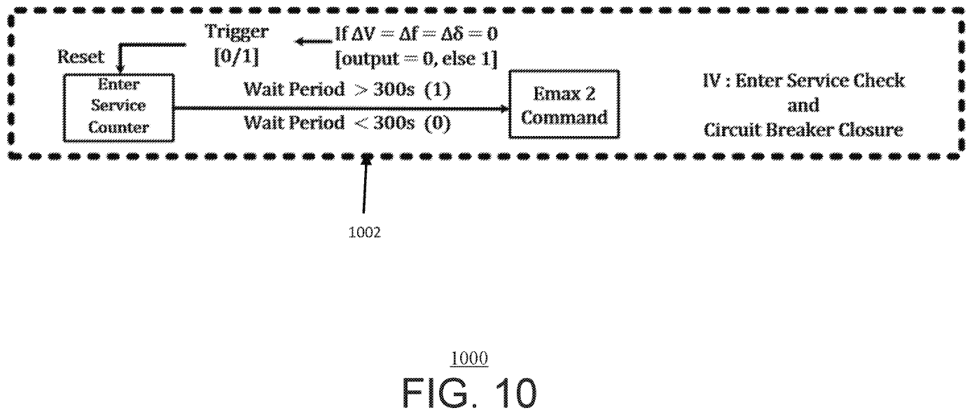

After all the PCC waveform parameters of voltage (e.g., magnitude, frequency, and phase) are aligned and within a tolerance band, the computing system moves onto the next sequence in the algorithm, the Enter Service Check and Circuit Breaker Closure (Algorithm Sequence IV 1002) shown in FIG. 10. The Enter Service specifications are defined as user-defined intentional delay (e.g., 0-600 seconds) when the micro-grid steady-state voltage and frequency are within range specified as per the Institute of Electrical and Electronics Engineers (IEEE) Standard 1547, Table 4. After the Enter Service wait period is over, the computing system finishes the resynchronization process with the PCC circuit breaker closure and toggling the DER control into following mode. At this stage, the micro-grid moves into grid-connected mode with the closure of the PCC circuit breaker. This marks the end of the resynchronization process.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. For example, the various embodiments of the kinematic, control, electrical, mounting, and user interface subsystems can be used interchangeably without departing from the scope of the invention. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for synchronizing a micro-grid with a larger electrical grid, comprising:
receiving, by a computing system, a plurality of first sensor measurements from one or more first sensors, wherein the plurality of first sensor measurements indicate first magnitude, first frequency, and first angle measurements on a micro-grid side of a circuit breaker that electrically connects the micro-grid to the larger electrical grid;
receiving, by the computing system, a plurality of second sensor measurements from one or more second sensors, wherein the plurality of second sensor measurements indicate second magnitude, second frequency, and second angle measurements on a larger grid side of the circuit breaker;
determining, by the computing system, whether the micro-grid is synchronized with the larger electrical grid based on the plurality of first sensor measurements and the plurality of second sensor measurements;
based on the micro-grid being not synchronized with the larger electrical grid, controlling, by the computing system, one or more energy assets of the micro-grid by providing one or more correcting characteristics to the one or more energy assets; and
based on the micro-grid being synchronized with the larger grid, providing, by the computing system, instructions to the circuit breaker to connect the micro-grid to the larger electrical grid.

2. The method of claim 1, further comprising:
receiving, from a static transfer switch, larger grid information indicating a health of the larger electrical grid;
determining a state of the micro-grid, wherein the state indicates whether the micro-grid is in a connected state or an island state, and
wherein determining whether the micro-grid is synchronized with the larger electrical grid is further based on the larger grid information indicating the larger electrical grid is healthy and the state of the micro-grid indicates that the micro-grid is in the island state.

3. The method of claim 1, wherein the circuit breaker is a point of common coupling (PCC) between the micro-grid and the larger electrical grid, wherein the one or more first sensors are configured to obtain the plurality of first sensor measurements from one or more electrical lines that connect the micro-grid to the circuit breaker, and wherein the one or more second sensors are configured to obtain the plurality of second sensor measurements from one or more electrical lines that connect the circuit breaker to the larger electrical grid.

4. The method of claim 1, wherein determining whether the micro-grid is synchronized with the larger electrical grid comprises:
determining a difference between the first magnitude with the second magnitude, wherein the first magnitude and the second magnitude indicate voltage magnitude measurements;
comparing the difference with one or more thresholds; and
determining whether the micro-grid is synchronized based on the comparison.

5. The method of claim 1, wherein determining whether the micro-grid is synchronized with the larger electrical grid comprises:
determining a difference between the first frequency with the second frequency, wherein the first frequency and the second frequency indicate frequencies of voltage waveforms;
comparing the difference with one or more thresholds; and
determining whether the micro-grid is synchronized based on the comparison.

6. The method of claim 1, wherein determining whether the micro-grid is synchronized with the larger electrical grid comprises:
determining a difference between the first angle with the second angle, wherein the first angle and the second angle indicate phase angles;
comparing the difference with one or more thresholds; and
determining whether the micro-grid is synchronized based on the comparison.

7. The method of claim 6, wherein determining the difference between the first angle with the second angle is based on the first magnitude being synchronized with the second magnitude and the first frequency being synchronized with the second frequency.

8. The method of claim 1, wherein the one or more correcting characteristics comprise a voltage magnitude resynchronization value, wherein the one or more energy assets adjusts a voltage magnitude of the micro-grid based on the voltage magnitude resynchronization value.

9. The method of claim 1, wherein the one or more correcting characteristics comprise a voltage frequency resynchronization value, wherein the one or more energy assets adjusts a voltage frequency of the micro-grid based on the voltage frequency resynchronization value.

10. The method of claim 1, wherein the one or more correcting characteristics comprise an angle error, wherein the one or more energy assets adjusts a voltage frequency of the micro-grid based on the angle error.

11. The method of claim 1, wherein providing the instructions to the circuit breaker further comprises:
obtaining, from the one or more first sensors, a plurality of subsequent sensor measurements during a waiting period;
determining whether the micro-grid is stable during the waiting period based on comparing the plurality of subsequent sensor measurements with one or more stability thresholds; and
based on determining the micro-grid is stable during the waiting period, providing the instructions to the circuit breaker to connect the micro-grid to the larger electrical grid.

12. The method of claim 11, further comprising:
receiving, by the computing system, user input indicating the waiting period.

13. The method of claim 1, wherein the plurality of first sensor measurements comprise a first set of sensor measurements obtained by the one or more first sensors at a first instance in time and a second set of sensor measurements obtained by the one or more first sensors at a second instance in time,
wherein determining whether the micro-grid is synchronized comprises:
determining whether the micro-grid is synchronized with the larger electrical grid at the first instance in time based on the first set of sensor measurements; and
determining whether the micro-grid is synchronized with the larger electrical grid at the second instance in time based on the second set of sensor measurements.

14. The method of claim 13, wherein controlling the one or more energy assets of the micro-grid by providing the one or more correcting characteristics to the one or more energy assets is based on determining that the micro-grid is not synchronized with the larger electrical grid at the first instance in time, and
wherein providing the instructions to the circuit breaker to connect the micro-grid to the larger electrical grid is based on determining that the micro-grid is not synchronized with the larger electrical grid at the second instance in time.

15. A system for synchronizing a micro-grid with a larger electrical grid, comprising:
a computing system, comprising:
one or more processors; and
a non-transitory computer-readable medium having processor-executable instructions stored thereon, wherein the processor-executable instructions, when executed by the one or more processors, facilitate:
receiving a plurality of first sensor measurements from one or more first sensors, wherein the plurality of first sensor measurements indicate first magnitude, first frequency, and first angle measurements on a micro-grid side of a circuit breaker that electrically connects the micro-grid to the larger electrical grid;
receiving a plurality of second sensor measurements from one or more second sensors, wherein the plurality of second sensor measurements indicate second magnitude, second frequency, and second angle measurements on a larger grid side of the circuit breaker;
determining whether the micro-grid is synchronized with the larger electrical grid based on the plurality of first sensor measurements and the plurality of second sensor measurements;
based on the micro-grid being not synchronized with the larger electrical grid, controlling one or more energy assets of the micro-grid by providing one or more correcting characteristics to the one or more energy assets; and
based on the micro-grid being synchronized with the larger grid, providing instructions to the circuit breaker to connect the micro-grid to the larger electrical grid.

16. The system of claim 15, wherein the processor-executable instructions, when executed by the one or more processors, further facilitate:
receiving, from a static transfer switch, larger grid information indicating a health of the larger electrical grid;
determining a state of the micro-grid, wherein the state indicates whether the micro-grid is in a connected state or an island state, and
wherein determining whether the micro-grid is synchronized with the larger electrical grid is further based on the larger grid information indicating the larger electrical grid is healthy and the state of the micro-grid indicates that the micro-grid is in the island state.

17. The system of claim 15, wherein the circuit breaker is a point of common coupling (PCC) between the micro-grid and the larger electrical grid, wherein the one or more first sensors are configured to obtain the plurality of first sensor measurements from one or more electrical lines that connect the micro-grid to the circuit breaker, and wherein the one or more second sensors are configured to obtain the plurality of second sensor measurements from one or more electrical lines that connect the circuit breaker to the larger electrical grid.

18. The system of claim 15, wherein determining whether the micro-grid is synchronized with the larger electrical grid comprises:
determining a difference between the first magnitude with the second magnitude, wherein the first magnitude and the second magnitude indicate voltage magnitude measurements;
comparing the difference with one or more thresholds; and
determining whether the micro-grid is synchronized based on the comparison.

19. The system of claim 15, wherein determining whether the micro-grid is synchronized with the larger electrical grid comprises:
determining a difference between the first frequency with the second frequency, wherein the first frequency and the second frequency indicate frequencies of voltage waveforms;
comparing the difference with one or more thresholds; and
determining whether the micro-grid is synchronized based on the comparison.

20. A non-transitory computer-readable medium having processor-executable instructions stored thereon, wherein the processor-executable instructions, when executed by one or more processors, facilitate:
receiving a plurality of first sensor measurements from one or more first sensors, wherein the plurality of first sensor measurements indicate first magnitude, first frequency, and first angle measurements on a micro-grid side of a circuit breaker that electrically connects a micro-grid to a larger electrical grid;
receiving a plurality of second sensor measurements from one or more second sensors, wherein the plurality of second sensor measurements indicate second magnitude, second frequency, and second angle measurements on a larger grid side of the circuit breaker;
determining whether the micro-grid is synchronized with the larger electrical grid based on the plurality of first sensor measurements and the plurality of second sensor measurements;
based on the micro-grid being not synchronized with the larger electrical grid, controlling one or more energy assets of the micro-grid by providing one or more correcting characteristics to the one or more energy assets; and
based on the micro-grid being synchronized with the larger grid, providing instructions to the circuit breaker to connect the micro-grid to the larger electrical grid.
